(19) United States
(12) Patent Application Publication
(10) Pub. No.: US 2019/0371543 A1
(43) Pub. Date: Dec. 5, 2019

(54) WATERPROOF ELECTRONIC DEVICE AND METHOD OF MANUFACTURING THE SAME

(71) Applicant: PEGATRON CORPORATION, Taipei City (TW)

(72) Inventors: Tsung-Han CHIANG, TAIPEI CITY (TW); Jiun-Wei LI, TAIPEI CITY (TW)

(21) Appl. No.: 16/407,417

(22) Filed: May 9, 2019

(30) Foreign Application Priority Data
Jun. 4, 2018 (TW) 107119215

(51) Int. Cl. H01H 13/06; H01H 13/86; H01H 13/705; G06F 3/02

(52) U.S. Cl. CPC H01H 13/06; H01H 13/86; H01H 2223/056; G06F 3/0202; H01H 2223/044; H01H 13/705

(57) ABSTRACT

A waterproof electronic device includes a keyboard module, a first case and a first waterproof layer. The keyboard module has a plurality of key caps. The first case is disposed over the keyboard module and the first case has a top surface. The top surface of the first case has a plurality of first opening exposing the key caps. The first waterproof layer covers the top surface of the first case and the key caps, and the first waterproof layer includes a fabric layer and a waterproof adhesive layer.

### CROSS-REFERENCE TO RELATED APPLICATION

This application claims priority to Taiwan Application Serial Number 107119215, filed Jun. 4, 2018, which is herein incorporated by reference.

### BACKGROUND

### Technology Field

The present disclosure relates to a waterproof electronic device and method of manufacturing the same.

### Description of Related Art

With the advancement of technology, various electronic products such as laptops, tablet computers, and smart phones have been widely used in daily life. Typically, electronic devices have interstices between components exposed to outside (for example, between the laptop case and the keycap of keyboard, or between the case and the touch pad). When using the electronic devices, dust, moisture, or other liquid in the external environment may enter the electronic device easily from the interstices, resulting damage of the electronic device.

Accordingly, there is a demand for an electronic device having a higher level of waterproof and dustproof protection to avoid the above problems.

### SUMMARY

In accordance with various embodiments of the present disclosure, a waterproof electronic device is provided. The waterproof electronic device includes a keyboard module, a first case, and a first waterproof layer. The keyboard module has a plurality of key caps. The first case is over the keyboard module, wherein the first case has a top surface, and the top surface has a plurality of first openings exposing the key caps. The first waterproof layer covers the top surface of the first case and the key caps, wherein the first waterproof layer includes a fabric layer and a waterproof adhesive layer.

According to some embodiments of the present disclosure, the waterproof electronic device further includes a touch pad module under the first case, wherein the touch pad module has a touch sensing area, the top surface of the first case has a second opening exposing the touch sensing area, and the first waterproof layer covers the touch sensing area.

According to some embodiments of the present disclosure, the fabric layer is on the waterproof adhesive layer.

According to some embodiments of the present disclosure, the fabric layer includes polyester, nylon, spandex, non-woven fabric, leather, or a combination thereof, and the waterproof adhesive layer includes Polyurethane (PU), rubber, or silicone.

According to some embodiments of the present disclosure, the waterproof electronic device further includes a second case and a second waterproof layer. The second case is disposed under the keyboard module, such that the keyboard module is disposed between the first case and the second case, and the second case has a bottom surface exposed to outside. The second waterproof layer covers the bottom surface of the second case.

According to some embodiments of the present disclosure, the waterproof electronic device further includes a first adhesive layer between the first waterproof layer and the top surface of the first case, wherein the first adhesive layer covers the top surface of the first case.

According to some embodiments of the present disclosure, the waterproof electronic device further includes a second adhesive layer between the key caps and the first waterproof layer, wherein the second adhesive layer covers a portion of each of the key caps.

In accordance with various embodiments of the present disclosure, a method of manufacturing a waterproof electronic device is provided. The method includes coating a shaping auxiliary adhesive on a first surface of a waterproof material; performing a vacuum forming process to form a plurality of key cap regions on the waterproof material; forming a first adhesive layer on a top surface of a first case, wherein the top surface of the first case has a plurality of first openings; and performing a attaching process to attach the first surface of the waterproof material to the top surface of the first case, wherein each of the key cap regions of the waterproof material is aligned with each of the first openings of the first case.

According to some embodiments of the present disclosure, the vacuum forming process includes forming a touch pad region of the waterproof material, wherein the top surface of the first case has a second opening, and the touch pad region is aligned with the second opening during the attaching process.

According to some embodiments of the present disclosure, the attaching process comprises: placing the waterproof material in a first jig; heating the waterproof material to a temperature of about 70-80° C.; and evacuating from the first surface of the waterproof material about 20-30 second.

According to some embodiments of the present disclosure, the attaching process comprises: placing the waterproof material and the first case in a second jig; and heating the first adhesive layer at a temperature of about 115-125° C., such that the first surface of the waterproof material is attached to the top surface of the first case by the first adhesive layer.

According to some embodiments of the present disclosure, the waterproof material includes a fabric layer and a waterproof adhesive layer.

According to some embodiments of the present disclosure, the shaping auxiliary adhesive has a thickness of about 0.02-0.07 mm.

It is to be understood that both the foregoing general description and the following detailed description are by examples, and are intended to provide further explanation of the disclosure as claimed.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1-2 are explosion diagrams of a waterproof electronic device in accordance with various embodiments of this invention.

FIG. 3 is a flow chart illustrating a method of manufacturing a waterproof electronic device in accordance with various embodiments of this invention.

FIGS. 4-7 are perspective view of various stages in the manufacturing of a waterproof electronic device in accordance with various embodiments of this invention.

### DETAILED DESCRIPTION

In order to make the description of the present disclosure more detailed and complete, the following illustratively describes implementation aspects and specific embodiments of the present disclosure; however, this is not the only form in which the specific embodiments of the present disclosure are implemented or utilized. The embodiments disclosed below may be combined with or substituted by each other in an advantageous manner, and other embodiments may be added to an embodiment without further recording or description. In the following description, numerous specific details will be described in detail to enable readers to fully understand the following embodiments. However, the embodiments of the present disclosure may be practiced without these specific details.

Furthermore, spatial relative terms, such as “below”, “under”, “above”, “over”, etc., are intended to facilitate description of the relative relationship between a component or feature and another component or feature, as shown in the drawings. The true meaning of these spatial relative terms includes other orientations. For example, when the illustration is flipped up and down by 180 degrees, the relationship between a component and another component may change from “below” or “under” to “above” or “over”. Furthermore, the spatial relative narratives used herein should be interpreted the same.

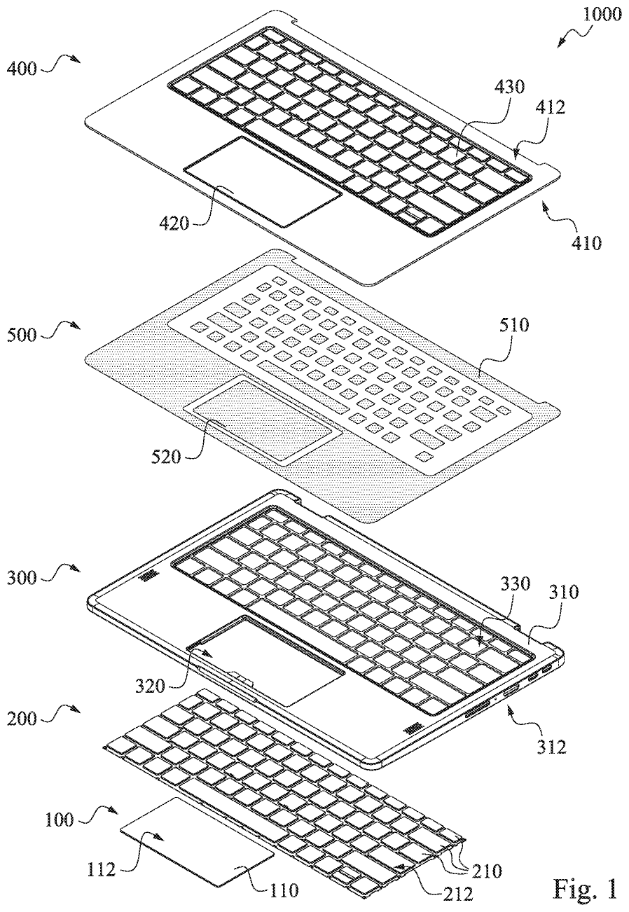

FIG. 1 is an explosion diagram of a waterproof electronic device 1000 in accordance with various embodiments of this invention. The waterproof electronic device 1000 includes a touch pad module 100, a keyboard module 200, a first case 300, and a first waterproof layer 400. According to various embodiments of the present invention, the waterproof electronic device 1000 may be, but is not limited to a laptop. The waterproof electronic device 1000 may optionally include other elements, which are described hereinafter.

Please refer to FIG. 1. The touch pad module 100 has a touch sensing area 110, and the touch sensing area 110 has a top surface 112. The keyboard module 200 has a plurality of key caps 210, and each of the key caps 210 has a top surface 212 isolated from each other. In some embodiments, each of the key caps 210 may have different size and shape, respectively. It is understood that the configuration, the number, the size, and the shape of the touch sensing area 110 and the key cap 210 shown in FIG. 1 are examples, the configuration, the number, the size, and the shape of the touch sensing area 110 and the key cap 210 can be changed depending on the need.

The first case 300 is over the touch pad module 100 and the keyboard module 200. The first case 300 has a top surface 310, a bottom surface 312, a second opening 320, and a plurality of first openings 330. The second opening 320 exposes the touch sensing area 110 of the touch pad module 100, and the first openings 330 expose the key caps 210 of the keyboard module 200. As shown in FIG. 1, the second opening 320 is aligned with the touch sensing area 110, and each of the first openings 330 is aligned with a key cap 210, respectively. The configuration, the number, the size, and the shape of the second opening 320 and the first opening 330 respectively correspond to the touch sensing area 110 and the key cap 210 aligned therewith. In some embodiments, the top surface 112 of the touch sensing area 110 is lower than the top surface 310 of the first case 300. In some embodiments, each of the key caps 210 respectively protrudes from the top surface 310 of the first case 300 through the aligned first opening 330. According to various embodiments of the present invention, the material of the first case 300 includes metal, metal alloy, or plastic. In some embodiments, the first case 300 may be aluminum alloy. According to various embodiments of the present invention, the waterproof electronic device 1000 may further include other electronic components such as circuit board, battery, or other suitable electronic components disposed under the first case 300.

The first waterproof layer 400 covers the top surface 310 of the first case 300, the touch sensing area 110, and the key caps 210. According to various embodiments of the present invention, the first waterproof layer 400 includes fabric layer and waterproof adhesive layer. In various embodiments, the fabric layer may carry the waterproof adhesive layer. For example, the waterproof adhesive layer may be on at least one surface of the fabric layer. In some embodiments, the fabric layer may have a textile feeling. For example, the fabric layer may be a textile. In some embodiments, the fabric layer may include, but is not limited to polyester, nylon, spandex, or a combination thereof. In other embodiments, the fabric layer may include non-woven fabric, leather, or other suitable materials. In some embodiments, the waterproof adhesive layer may be, but is not limited to Polyurethane (PU), rubber, or silicone. In some examples, the waterproof adhesive layer may permeate into and combine with the fabric layer. As shown in FIG. 1, the first waterproof layer 400 has a first surface 410, a second surface 412, a touch pad region 420, and a plurality of key cap regions 430. The touch pad region 420 is aligned with the second opening 320 of the first case 300 and the touch sensing area 110 of the touch pad module 100. Each of the key cap regions 430 is respectively aligned with one of the first openings 330 of the first case 300 and one of the key caps 210 of the keyboard module 200. Further, the number, the size, and the shape of the touch pad region 420 and key cap region 430 respectively correspond to the second opening 320, the touch sensing area 110, the first opening 330, and the key cap 210 aligned therewith. In some embodiments, the touch pad region 420 is recessed toward the first surface 410 of the first waterproof layer 400. In some embodiments, each of the key cap regions 430 protrudes from the second surface 412 of the first waterproof layer 400.

Still refer to FIG. 1. In some embodiments, the waterproof electronic device 1000 further includes adhesive layer 500 disposed between the first surface 410 of the first waterproof layer 400 and the top surface 310 of the first case 300. In some embodiments, the adhesive layer 500 includes a first adhesive layer 510 and a second adhesive layer 520. The first adhesive layer 510 covers the top surface 310 of the first case 300. The second adhesive layer 520 is between the first surface 410 of the first waterproof layer 400 and the top surface 112 of the touch sensing area 110, and between the first surface 410 of the first waterproof layer 400 and each of the key caps 210. In some embodiments, the first adhesive layer 510 and the second adhesive layer 520 may be hot melt adhesive. In some embodiments, the second adhesive layer 520 covers a portion of the touch sensing area 110 and a portion of each of the key caps 210. For example, the second adhesive layer 520 is reduced inward by about 1-3 mm from a edge of the top surface 112 of the touch sensing area 110, and is reduced inward by about 1-3 mm from a edge of the top surface 212 of the key cap 210. The second adhesive layer 520 partially covers the touch sensing area 110 and the key cap 210 to prevent the first case 300, the touch sensing area 110, and the key cap 210 from firmly sticking to the first waterproof layer 400 in subsequent processes such that the touch pad module 100 and the keyboard module 200 cannot be pressed.

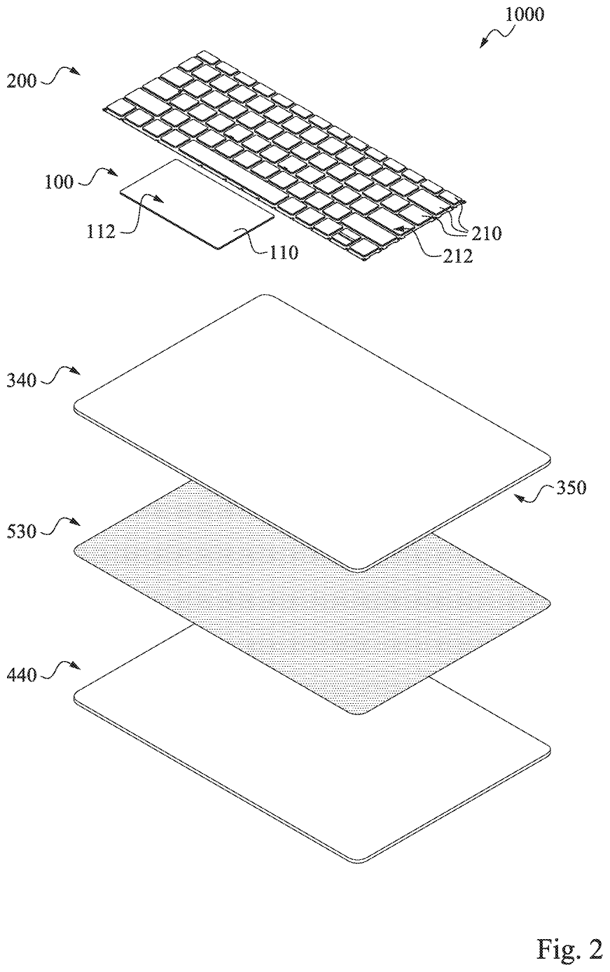

FIG. 2 is an explosion diagram of a waterproof electronic device 1000 in accordance with various embodiments of this invention. Please refer to FIG. 2. In some embodiments, the waterproof electronic device 1000 further includes a second case 340 and a second waterproof layer 440. The second case 340 is disposed under the touch pad module 100 and the keyboard module 200, such that the touch pad module 100 and the keyboard module 200 are disposed between the first case 300 and the second case 340. The second case 340 has a bottom surface 350 exposed to outside, and the second waterproof layer 440 covers the bottom surface 350 of the second case 340. In some embodiments, the waterproof electronic device 1000 further includes a third adhesive layer 530 between the second waterproof layer 440 and the second case 340. The material of the second case 340 may be the same as the first case 300, and the material of the second waterproof layer 440 may be the same as the first waterproof layer 400, and will not be repeated hereafter.

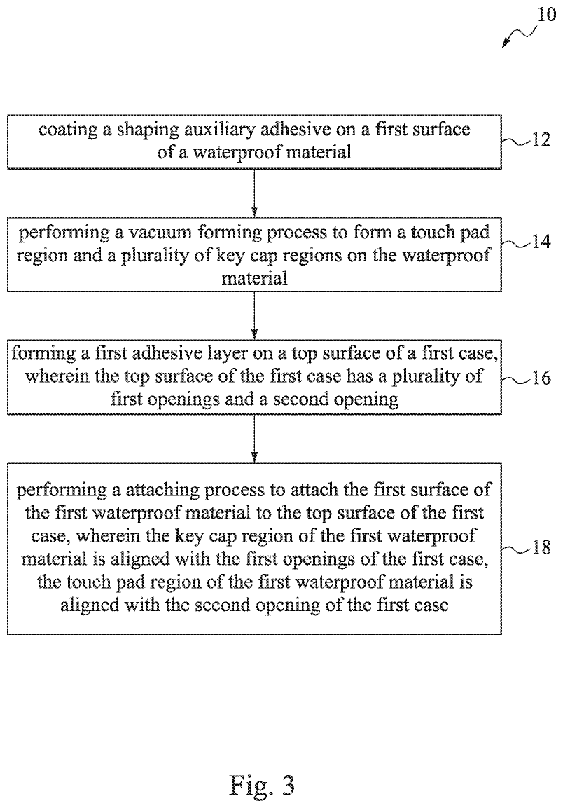

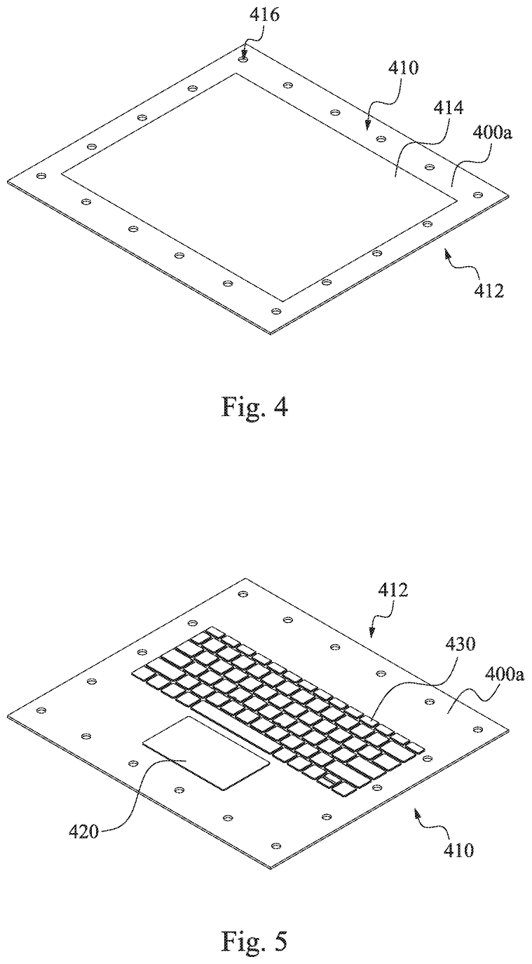

FIG. 3 is a flow chart illustrating a method 10 of manufacturing a waterproof electronic device 1000 in accordance with various embodiments of this invention. As shown in FIG. 3, the method 10 includes operation 12, operation 14, operation 16, and operation 18. FIGS. 4-7 are perspective view of various stages in the manufacturing of a waterproof electronic device 1000 in accordance with the method 10 illustrated in FIG. 1.

Please refer to FIG. 3 and FIG. 4, in operation 12 of method 10, a shaping auxiliary adhesive 414 is coated on a first surface 410 of a first waterproof material 400a. In various embodiments, the first waterproof material 400a includes fabric layer and waterproof adhesive layer (not shown) In some embodiments, the shaping auxiliary adhesive 414 may be coated on the waterproof adhesive layer of the first waterproof material 400a. In some embodiments, the fabric layer may have a textile feeling. For example, the fabric layer may be a textile. In some embodiments, the fabric layer includes, but is not limited to polyester, nylon, spandex, or a combination thereof. In other embodiments, the fabric layer includes non-woven fabric, leather, or other suitable materials. In some embodiments, the waterproof adhesive layer includes, but is not limited to Polyurethane (PU), rubber, or silicone. In some embodiments, the shaping auxiliary adhesive 414 covers at least the position that the touch pad region 420 and the key cap region 430 formed in the subsequent operation of the first surface 410 of the first waterproof material 400a. The shaping auxiliary adhesive 414 may be heated and can assist the first waterproof material 400a to shape and hold the touch pad region 420 and the key cap region 430 in the subsequent vacuum forming process. In some embodiments, a thickness of the shaping auxiliary adhesive 414 is about 0.02-0.07 mm, but is not limited thereto, a suitable thickness of the shaping auxiliary adhesive 414 can be selected depending on the need. In some embodiments, the first waterproof material 400a has a plurality of holes 416, such that it can be easily aligned with the first case 300 in the subsequent vacuum forming process and attaching process.

Please refer to FIG. 3 and FIG. 5, in the operation 14 of method 10, a vacuum forming process is performed to form the touch pad region 420 and the key cap regions 430 of the first waterproof material 400a. In various embodiments, the vacuum forming process includes placing the first waterproof material 400a in a first jig (not shown), heating the first waterproof material 400a to a temperature of about 70-80° C., and evacuating from the first surface 410 of the first waterproof material 400a about 20-30 second. Heating the first waterproof material 400a to this temperature can prevent the waterproof adhesive layer of the first waterproof material 400a from separating from the fabric layer to lose waterproof effect. In some embodiments, the touch pad region 420 is recessed toward the first surface 410 of the first waterproof material 400a. In some embodiments, each of the key cap regions 430 protrudes from the second surface 412 of the first waterproof material 400a. In some embodiments, after performing the vacuum forming process to form touch pad region 420 and key cap regions 430, cooling the first waterproof material 400a to shape the touch pad region 420 and the key cap regions 430.

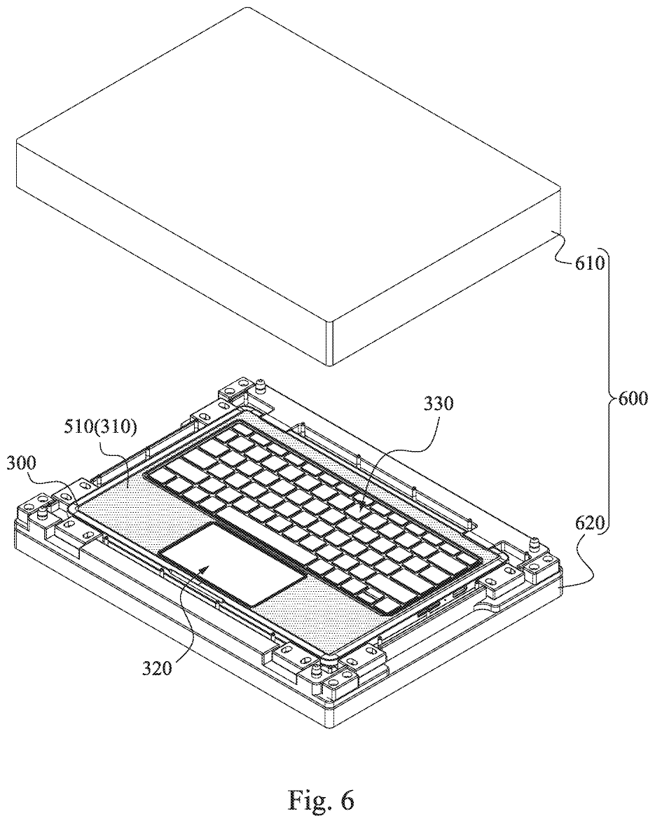

Please refer to FIG. 3 and FIG. 6, in the operation 16 of method 10, a first adhesive layer 510 is formed on the top surface 310 of the first case 300, in which the top surface 310 of the first case 300 has a second opening 320 and a plurality of first openings 330. In some embodiments, the first adhesive layer 510 may be, but is not limited to, hot melt adhesive.

Please refer to FIG. 3 and FIGS. 5-6, in the operation 18 of method 10, a attaching process is performed to attach the first surface 410 of the first waterproof material 400a (shown in FIG. 5) to the top surface 310 of the first case 300 (shown in FIG. 6), in which the touch pad region 420 of the first waterproof material 400a is aligned with the second opening 320 of the first case 300, each of the key cap regions 430 of the first waterproof material 400a is aligned with one of the first openings 330 of the first case 300. After performing the attaching process, the first waterproof material 400a covers the top surface 310, the second opening 320 and the first openings 330 of the first case 300. In various embodiments, the attaching process includes placing the first waterproof material 400a and the first case 300 in a second jig 600 (shown in FIG. 6), and heating the first adhesive layer 510 at a temperature of about 115-125° C., such that the first surface 410 of the first waterproof material 400a is attached to the top surface 310 of the first case 300 by the first adhesive layer 510. In some embodiments, the second jig 600 includes a top portion 610 and a bottom portion 620. In some embodiments, the top portion 610 of the second jig 600 has a protruding part and a recessed part (not shown). The protruding part corresponds to the touch pad region 420 of the first waterproof material 400a, and the recessed part corresponds to the key cap regions 430 of the first waterproof material 400a. In some embodiments, the bottom portion 620 of the second jig 600 has a shape that matches the top portion 610.

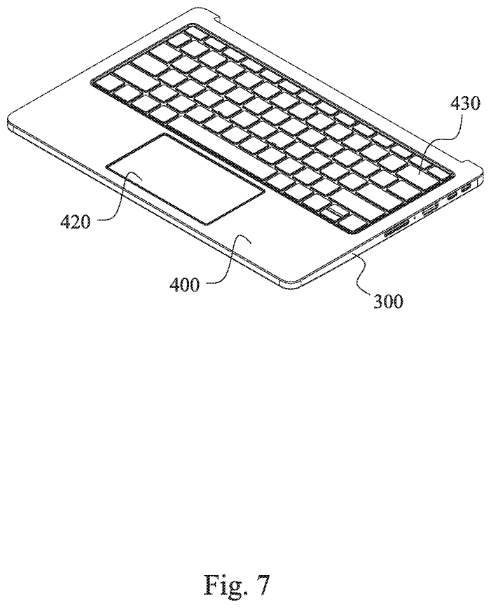

Please refer to FIG. 7. In some embodiments, the method 10 further includes cutting a portion of the first waterproof material 400a exceeded the top surface 310 of the first case 300 to form a first waterproof layer 400. For example, cutting the first waterproof material 400a exceeded the top surface 310 of the first case 300 by laser cutting. The first waterproof layer 400 is formed integrally and completely covers the top surface 310 of the first case 300, the second opening 320 and the plurality of first openings 330, thereby preventing liquid or dust from penetrating into the electronic device 1000 from the top surface 310 of the first case 300.

In some embodiments, the method 10 further includes forming a second waterproof layer 440 under the bottom surface 350 of the second case 340 (shown in FIG. 2). The aforementioned touch pad module 100, the keyboard module 200, and other electronic components (not shown) are then disposed between the second case 340 having the second waterproof layer 440 and the first case 300 having the first waterproof layer 400.

As described above, according to the embodiments of the present invention, vacuum forming the first waterproof material and then the first waterproof material is attached to to the top surface of the first case of the electronic device to form the integrally formed first waterproof layer. The aforementioned first waterproof layer completely covers the top surface of the first case, the touch sensing area of the touch pad module and the key cap region of the keyboard module. That is, the top surface of the first case, the touch pad module, and the keyboard module are not exposed to the outside, so that liquid and dust can be prevented from penetrating into the electronic device from interstices between the first case and the touch pad module (or the keyboard module) to be rated IP68 which is waterproof and dustproof.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A waterproof electronic device, comprising:
a keyboard module having a plurality of key caps;
a first case being over the keyboard module, wherein the first case has a top surface, and the top surface has a plurality of first openings exposing the key caps; and
a first waterproof layer covering the top surface of the first case and the key caps, wherein the first waterproof layer comprises a fabric layer and a waterproof adhesive layer.

2. The waterproof electronic device of claim 1, further comprising a touch pad module under the first case, wherein the touch pad module has a touch sensing area, the top surface of the first case has a second opening exposing the touch sensing area, and the first waterproof layer covers the touch sensing area.

3. The waterproof electronic device of claim 1, wherein the fabric layer is on the waterproof adhesive layer.

4. The waterproof electronic device of claim 1, wherein the fabric layer comprises polyester, nylon, spandex, non-woven fabric, leather, or a combination thereof, and the waterproof adhesive layer comprises Polyurethane (PU), rubber, or silicone.

5. The waterproof electronic device of claim 1, further comprising:
a second case disposed under the keyboard module, such that the keyboard module is disposed between the first case and the second case, wherein the second case has a bottom surface exposed to outside; and
a second waterproof layer covering the bottom surface of the second case.

6. The waterproof electronic device of claim 1, further comprising a first adhesive layer between the first waterproof layer and the top surface of the first case, wherein the first adhesive layer covers the top surface of the first case.

7. The waterproof electronic device of claim 6, further comprising a second adhesive layer between the key caps and the first waterproof layer, wherein the second adhesive layer covers a portion of each of the key caps.

8. A method of manufacturing a waterproof electronic device, comprising:
coating a shaping auxiliary adhesive on a first surface of a waterproof material;
performing a vacuum forming process to form a plurality of key cap regions on the waterproof material;
forming a first adhesive layer on a top surface of a first case, wherein the top surface of the first case has a plurality of first openings; and
performing a attaching process to attach the first surface of the waterproof material to the top surface of the first case, wherein each of the key cap regions of the waterproof material is aligned with each of the first openings of the first case.

9. The method of claim 8, wherein the vacuum forming process comprises forming a touch pad region of the waterproof material, wherein the top surface of the first case has a second opening, and the touch pad region is aligned with the second opening during the attaching process.

10. The method of claim 8, wherein the vacuum forming process comprises: placing the waterproof material in a first jig;
heating the waterproof material to a temperature of about 70-80° C.; and
evacuating from the first surface of the waterproof material about 20-30 seconds.

11. The method of claim 8, wherein the attaching process comprises:
placing the waterproof material and the first case in a second jig; and
heating the first adhesive layer at a temperature of about 115-125° C., such that the first surface of the waterproof material is attached to the top surface of the first case by the first adhesive layer.

12. The method of claim 8, wherein the waterproof material comprises a fabric layer and a waterproof adhesive layer.

13. The method of claim 8, wherein the shaping auxiliary adhesive has a thickness of about 0.02-0.07 mm.
